(19) United States
(12) Patent Application Publication
(10) Pub. No.: US 2026/0023229 A1
(43) Pub. Date: Jan. 22, 2026

(54) SYSTEM AND METHOD FOR A HIGH-DENSITY OPTICAL CONNECTOR WITH DUAL LAYER MIRRORS IN PHOTONIC INTEGRATED CIRCUITS

(71) Applicant: MIXX TECHNOLOGIES, INC., San Jose, CA (US)

(72) Inventors: Rebecca Kayla Schaevitz, Sunnyvale, CA (US); Vivek Raghuraman, San Jose, CA (US); Qijun Xiao, Fremont, CA (US); Sean Sane Foreman Cassidy, San Jose, CA (US)

(73) Assignee: MIXX TECHNOLOGIES, INC., San Jose, CA (US)

(21) Appl. No.: 19/273,083

(22) Filed: Jul. 17, 2025

Related U.S. Application Data
(60) Provisional application No. 63/672,637, filed on Jul. 17, 2024.

(51) Int. Cl. G02B 6/42

(52) U.S. Cl. CPC G02B 6/4293; G02B 6/4214; G02B 6/4215; G02B 6/4231

(57) ABSTRACT

An upper body collimator includes a first body including more than two rows of fiber alignment holes. One or more alignment features are configured to mate and/or demate with a second body external to the upper body collimator. One or more optical structures including one or more: waveguides, lenses, mirrors, and/or light manipulating surfaces. The more than two rows of fiber alignment holes and the one or more optical structures are collectively configured to emit collimated light across an interface with the second body, with a tolerance to lateral and/or angular misalignment.

### CROSS-REFERENCE TO RELATED APPLICATIONS

This application claims priority to U.S. Patent Application No. 63/672,637, filed Jul. 17, 2024, titled SYSTEM AND METHOD FOR AN OPTICAL CONNECTOR WITH DUAL LAYER MIRRORS IN PHOTONIC INTEGRATED CIRCUITS, which is incorporated herein by reference in its entirety.

### BACKGROUND

Artificial Intelligence (AI) is driving a critical need for dramatic advancements in communication bandwidth and radix between xPUs (compute units such as GPUs, CPUs, TPUs, and NPUs). As computational capabilities scale, doubling approximately every two years, the bandwidth improvements lag behind, increasing by only 1.3 times within the same period. The emergence of new models, training requirements, and infrastructure necessitates a significant shift in technology to enable better communication within these systems

Historically, core compute units (xPUs) communicate off-package through electrical signaling using serializer/deserializer (SerDes) technology. This technology must be robust enough to overcome significant electrical losses incurred during transmission between two boxes, including losses from associated PCBs, connectors, and cables. Typically, these connections employ a range of solutions from coaxial copper cables, limited to less than 2 meters of transit length, to pluggable transceivers that convert electrical signals to optical signals, allowing for longer distances ranging from 50 meters to 2 kilometers or even beyond. Accommodating such substantial losses requires the SerDes to occupy a large portion of the core compute ASIC, consuming significant power and opportunity cost for more compute. Additionally, the pluggable transceivers further increase power consumption to facilitate optical signal conversion for longer transmissions. All implementations use a large area and substantially decrease the density possible to scale AI into the future.

### SUMMARY

Some embodiments include a semiconductor package with an embedded electrical-to-optical converter (hereinafter “oEngine”), designed to have the highest density bandwidth and radix, improved manufacturability aligned to industry manufacturing processes, low power and high reliability. To enable such high density requires connecting many optical fibers to the package that aligns with established volume semiconductor processes. To achieve these design requirements, the optical subassembly comprises four main bodies: a fiber ferrule, a lower reflector body, a middle body collimator (MBC), and an upper body collimator (UBC). In some embodiments, the fiber ferrule body is integrated with the UBC as a single body. The fiber ferrule is fabricated from materials that offer durability and minimal optical interference, and is designed with high precision to match the pitch and alignment requirements of the optical fibers to the waveguides, minimizing insertion loss and maximizing coupling efficiency.

In some embodiments, positioned to receive light signals from silicon waveguides, the lower reflector body incorporates reflective surfaces that capture and redirect these signals towards the MBC. The lower reflector body can also reshape the optical beam into different mode profiles as needed. The lower reflector body is made from materials to ensure minimal light scattering and optimal reflection angles while being able to go through the advanced manufacturing processes, such as CoWoS (Chip on Wafer on Substrate integration).

In some embodiments, the middle body collimator (MBC) may include an Optical Redistribution Layer (ORDL) that operates to redistribute optical signals between the waveguides and the output fibers. The MBC may be made from lenses or mirrors on both its top and bottom halves. This arrangement can spread light (ORDL function) from a tightly packed waveguide array to a more widely spaced fiber array, matching a fiber pitch as small as 50 um up to a standard pitch of 250 um, and can also reshape the light into different mode profiles to match the PIC waveguide on one side and the UBC on the other (the collimator function). In some embodiments, the MBC includes alignment holes for precise positioning of the UBC and the fiber ferrule and is designed to enable pluggability, facilitating vertical testing and wafer-scale assembly. In other embodiments, the alignment holes are a separate piece part that integrates with the MBC. In some embodiments, the MBC only changes the mode profile of the light, not the position. In some embodiments, the MBC only acts as a mechanical positioner and aligner.

In some embodiments, positioned above the MBC, the upper body collimator (UBC) contains additional reflective surfaces that capture light from the MBC and guide light towards the fiber ferrule in the same plane as the PIC. The UBC has features that convert the mode between the fiber mode and the mode matched to the MBC. In some embodiments, The UBC includes features that align with the MBC and fiber ferrule to ensure seamless light transition and is fabricated from transparent (at the wavelength of operation) materials with precision surfaces to maintain signal quality and the ability to create high-reflectivity surfaces as needed. Some embodiments integrate the UBC with the fiber ferrule body, to enhance efficiency, reduce complexity, and improve mechanical stability. Such integrated design allows for reduced manufacturing complexity, improved alignment, and a minimized footprint, making the oEngine suitable for applications with stringent space constraints.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is noted, however, that the appended drawings illustrate only some aspects of this disclosure and the disclosure may admit to other equally effective embodiments.

To facilitate understanding, identical reference numerals have been used, where possible, to designate identical elements that are common to the figures. It is contemplated that elements and features of one embodiment may be beneficially incorporated in other embodiments without further recitation.

FIG. 1 illustrates a schematic of an exemplary optical subassembly, in accordance with some embodiments;

FIG. 2A-2D illustrate schematics of exemplary components for an optical subassembly, in accordance with some embodiments;

FIG. 3A-3B illustrate schematics of exemplary components for an optical subassembly, in accordance with some embodiments;

FIGS. 4A-4C illustrate a schematic of an exemplary optical subassembly, in accordance with some embodiments;

FIG. 5 illustrates schematics of an exemplary component for an optical subassembly, in accordance with some embodiments;

FIGS. 6A-6C illustrate a schematic of an exemplary optical subassembly, in accordance with some embodiments; and

FIGS. 7A-7E illustrate schematics of exemplary components for an optical subassembly, in accordance with some embodiments.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include embodiments implemented in software, or combinations of software and hardware, and vice-versa, as will be apparent to those skilled in the art, unless otherwise specified herein. In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The embodiments described herein relate generally to Photonic Integrated Circuits (PICs) featuring the highest density fiber connector to silicon, optimized for compatibility with volume wafer-scale manufacturing processes. The embodiments herein achieve a fiber density that is nearly twice as high as any current development or productized solution, fitting within the tight volume constraints defined by AI package designs. For example, the embodiments described herein can achieve densities including 160 fibers in a 12 mm width including the mechanical elements to enable detachability, which translates to approximately 13.3 fibers per millimeter. For example, some state-of-the-art solutions may provide approximately 160 fibers in one reticle edge of 26 mm thereby achieving a density of 6.1 fibers per millimeter. Other solutions have demonstrated the ability to provide 64 fibers along one reticle edge achieving a density of 2.5 fibers per millimeter. Another solution has also shown a capability of integrating 64 fibers within a 7 mm width PIC, achieving a density of 9.1 fibers per millimeter. Some embodiments herein provide 40 fibers in 1.4 mm, without considering the mechanical element, or, in some embodiments a density of 28.5 fibers/mm using standard 125 um fibers. To compare, other solutions using standard fibers have demonstrated a fiber pitch of 127 um in one row and 62.5 um in two rows, or equivalently 8 fibers/mm or 16 fibers/mm, respectively. Such comparisons highlight the significant advancement in fiber density offered by the embodiments described herein, positioning them at the forefront of PIC technology for AI package designs and other high-density applications. Additionally, the embodiment discussed herein is the first demonstration of a high-density connector with more than two rows of fibers for PIC integration, thus providing a pathway to further improvements in density and number of fibers over time.

Some embodiments described herein may implement optical mirrors (flat or curved), optical lenses, optical waveguides, turning elements, and/or mechanical mating features. Such elements facilitate early testing at the wafer scale, ensuring consistency with final product performance. Moreover, the architecture is specifically designed to support testing at volume scale, matching the throughput and automation capabilities of traditional semiconductor testing workflows. The integration of mechanical alignment features and sealed optical paths enables non-destructive, high-throughput optical and electrical validation prior to dicing, improving yield and reducing cost. The precise integration of optical and mechanical elements is carefully engineered to fit within the die boundaries. The embodiments described herein provide an optical subassembly having very low optical loss that is both polarization and wavelength insensitive, enabling support for future scaling across multiple wavelengths. Such compatibility ensures that the system can evolve with advancing technology requirements.

In addition to offering best-in-class density and radix, the embodiments herein support early testing that correlates with final product results, ensuring reliability from development through to production. This breakthrough enables the industry to achieve exceptional radix within a remarkably small form factor, matched to the pitch of core ASICs, and capable of scaling in both wavelength and speed in future applications. For example, in some embodiments, middle body collimator (MBC) includes dual-layer mirrors that converts the mode from the PIC to a collimated mode matching the Upper Body Collimator (UBC). In other embodiments, this MBC can include an optical redistribution layer (ORDL) to redistribute light efficiently, from a tightly pitched waveguide array, to a spaced-out two-dimensional fiber array, or changing the angle of incident to convert between the PIC and the UBC, enabling high-density optical connections within photonic integrated circuits (PICs), which is discussed in detail further below. This MBC has an added advantage of keeping the light within the material and thus impervious to environmental impacts, such as dust and humidity, that can affect the optical loss or mode profile.

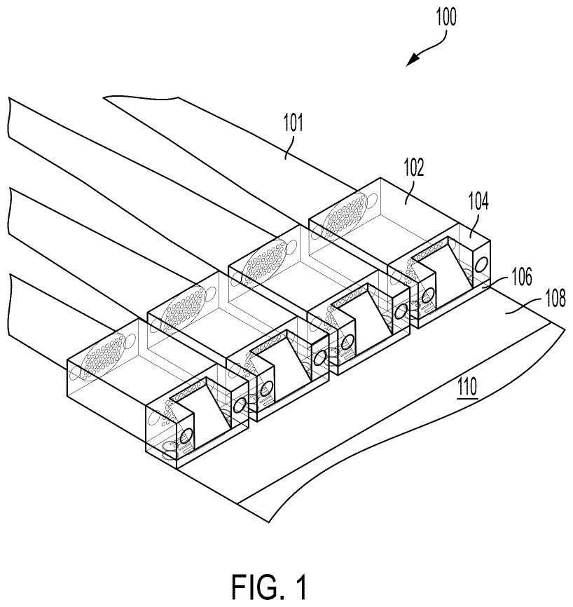

Referring now to FIG. 1, FIG. 1 depicts an optical subassembly 100 (“subassembly 100”). Subassembly 100 includes fiber cables 101, fiber ferrules 102, upper body collimator 104, middle body collimator 106, lower body reflector 108 and a photonic integrated circuit (PIC) 110. Subassembly 100 corresponds to an optical connector assembly having reflective elements for directing light. Discussed in detail below, subassembly 100 is advantageous for maintaining efficient light transmission, very high fiber density, fiber to PIC alignment, integration with established manufacturing processes and materials, protection to environmental effects such as dust and humidity and fiber pluggability in PICs.

In some embodiments, subassembly 100 includes optical fiber cable(s) 101 that carry light signals or light sources. Cable(s) 101 transmit light sources as well as data in the form of light between different components of the optical network employing subassembly 100. Fiber ferrules 102 align and protect the end of optical fibers in cables 101. Fiber ferrules 102 ensure precise alignment of optical fibers with the connectors to minimize signal loss. For example, in fiber ferrules 102, an individual ferrule aligns with one of the fibers within the fiber cable(s) 101. In some embodiments, alignment features exist for coupling fiber ferrules 102 to the upper body collimator 104 and may include holes, notches, protrusions, and the like. Such features may be implemented with pins and/or similar mechanical alignment mechanisms.

In some embodiments, fiber ferrule 102 and/or upper body collimator 104, and/or middle body collimator 106 may include one or more alignment features. For example, such alignment features may include mechanical features such as holes, notches, protrusions, and the like, which may be augmented with other components (e.g., pins, rod, or balls inserted into upper body collimator 104), which ensure precise mechanical alignment of the connectors with the corresponding parts of the optical subassembly. Such alignment features are advantageous for securing the ferrules and/or the upper body collimator 104 in place and maintaining alignment during assembly and operation, which is discussed in further detail below.

In some embodiments, upper body collimator 104, middle body collimator 106, and/or lower body reflector 108 may include features such as mirrors, lenses, and/or reflective surfaces. Such features redirect and/or reshape the incoming light signals from the optical fibers to the desired paths within subassembly 100 and are advantageous for directing and shaping light efficiently (i.e., with low insertion loss) within subassembly 100, which is discussed in detail further below. As shown in FIG. 1, subassembly 100 includes the lower body reflector 108. Lower body reflector 108 functions as light turning and reshaping element. Lower body reflector 108 facilitates light extraction of the PIC while staying within the confines of processes available in established wafer-scale manufacturing. Lower body reflector 108 ensures that light signals are properly transmitted with minimal loss.

In accordance with embodiments described herein, the optical structures, reflective elements, and mechanical alignment features of the subassemblies collectively implement an optical packaging protocol designed to enable scalable, reworkable, and robust packaging of photonic integrated circuits (PICs). Such protocol defines a standardized mechanical and optical interface between the PIC and optical connector components, including the lower body reflector, middle body collimator, and upper body collimator, allowing for modular assembly and improved compatibility with high-volume semiconductor packaging environments.

The lower body reflector (LBR), in some embodiments, is fabricated using standard PIC-compatible processes such as deep reactive ion etching (DRIE), thin film deposition, and lithographic patterning. The LBR may be integrated directly onto or into the PIC without requiring epoxy, underfill, or other organic bonding materials. In some embodiments, the LBR may be formed in silicon or glass using established back-end-of-line (BEOL) wafer processes, and subsequently bonded using oxide bonding, hybrid bonding, or passive alignment with etched z-stops. The exclusion of epoxy and organic adhesives within the optical path ensures long-term optical and thermal stability, particularly in applications involving high temperature, humidity, or fluidic immersion environments (e.g., immersion cooling).

Similarly, the middle body collimator may be manufactured and integrated using epoxy-free bonding processes. In some embodiments, the middle body collimator is fixedly attached to the package through direct wafer bonding, compression fitting, or mechanical registration features such as etched notches or mechanical guide pins. These techniques eliminate the need for organic adhesives within or near the optical path and allow for optical coupling that remains stable across temperature excursions, vibration, or environmental stress. The middle body collimator is configured to support polarization-independent, broadband operation by maintaining precise mirror or lens geometries aligned to the optical mode profile without reliance on fluid index-matching or gel-based adhesives.

The upper body collimator, in contrast, is designed to be removably coupled to the rest of the optical assembly. In some embodiments, the upper body collimator interfaces with one or more of a ring stiffener, lid, and/or substrate. Mechanical retention features such as latches, flexures, cantilevers, or snap-fit connectors may be used to enable passive pluggability, allowing for simplified assembly, serviceability, or component upgrades. This mechanical coupling design is further optimized to maintain alignment within a lateral and angular misalignment tolerance (e.g., ±20 μm or more) via a collimated optical interface. The pluggable nature of the upper body collimator aligns with the packaging protocol's goal of modular, fiber-aligned integration into system-level photonic assemblies.

All components of the optical packaging protocol are further designed to be compatible with JEDEC and semiconductor industry packaging standards, including compatibility with reflow soldering and high-temperature thermal excursions. This ensures that the optoelectronic assemblies described herein can be co-packaged with electronic integrated circuits, substrates, or other components using conventional assembly lines without requiring specialized low-temperature adhesives or restricted process flows. In some embodiments, the protocol allows for simultaneous placement of the electrical integrated circuit (EIC) and optical components using a single pick-and-place step, leveraging passive alignment features and vertical cavity designs.

The optical packaging protocol disclosed herein enables the creation of high-density, scalable optical interfaces that do not require active alignment or iterative tuning during manufacturing. Instead, mechanical datum features, etched stop layers, and standardized pitch definitions (e.g., for waveguides, fibers, or lenses) allow for purely visual or metrology-assisted alignment. This results in robust and repeatable performance across manufacturing lots, and reduces per-unit cost for high-volume production. Moreover, the use of epoxy-free interfaces and sealed optical paths enhances environmental resilience and supports long-term reliability, even under mechanical stress or thermal cycling. Together, these features establish a new standard for packaging photonics with the scalability and manufacturability required for next-generation data, AI, and telecommunications infrastructure.

For clarity, it should be noted that while certain components of the system, such as the upper body collimator or associated fiber ferrules, may utilize epoxy or other organic bonding materials to secure individual optical fibers within fiber alignment holes, such materials are limited to regions that are outside of the permanent optical path and do not interfere with light propagation through the core assembly. For example, epoxy may be used to retain fibers within the upper body collimator during ferrule preparation or module final assembly, particularly where the upper body collimator is configured to be pluggable or field replaceable.

In contrast, components that are fixedly attached to the photonic integrated circuit (PIC) or to the semiconductor package such as the lower body reflector and the middle body collimator are specifically configured to be integrated using wafer-compatible bonding techniques such as direct bonding, fusion bonding, or hybrid bonding, without the use of epoxy or other organic materials. This distinction ensures that the optical path traversing through fixed system elements remains free of contaminants, bubbles, or misalignment risks introduced by adhesive materials, thereby enabling broadband, polarization-independent optical coupling with minimal insertion loss and high reliability in thermally demanding environments.

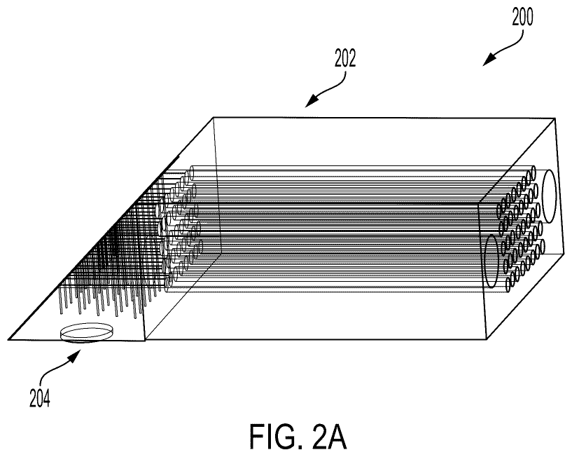

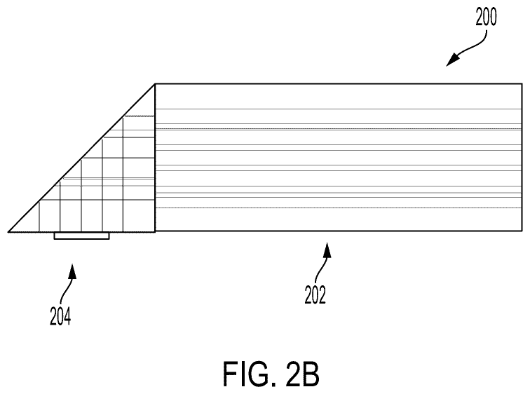

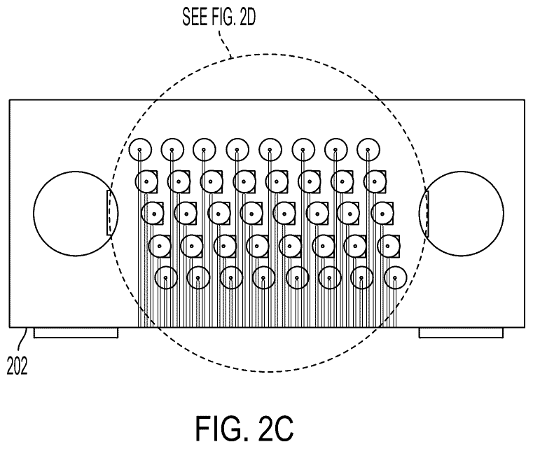

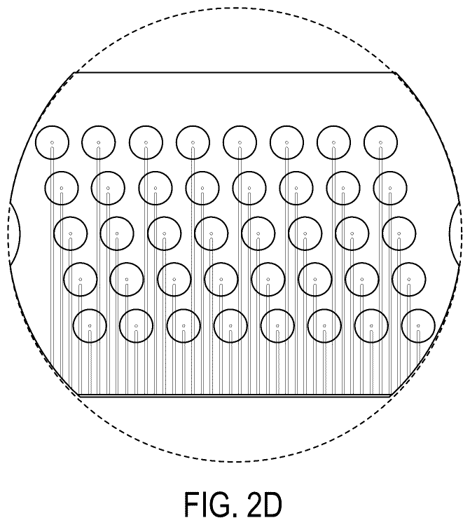

Referring now to FIGS. 2A-2D, FIG. 2A depicts an optical subassembly 200 (“subassembly 200”). Subassembly 200 provides a high-density optical waveguide assembly. In some embodiments, assembly 200 may include fiber ferrule body 202 coupled to collimator body 204. As shown in FIG. 2A, in some embodiments, waveguides are arranged in parallel, with smooth transitions and precise alignment to the fiber ensured by the support structures. Alignment features function to couple the fiber ferrule body 202 to the upper reflector body 204. In some embodiments, such coupling may either be fixedly attached or removably attached. In another implementation, fiber ferrule body 202 and upper reflector body 204 may be made as a singular, monolithic body.

As shown in FIG. 2B, subassembly 200 includes optimal waveguide pitch and spacing to maintain signal integrity and minimize crosstalk, highlighting the advanced engineering involved in creating this optical component for photonic integrated circuits, which is described in further detail below. In some embodiments subassembly 200 includes multiple optical waveguides, alignment structures 204, collimating elements and reflective elements, integrated into a compact layout. Subassembly 200 includes multiple channels for the optical fibers arranged in a high-density configuration.

FIG. 2C shows the layered configuration, illustrating how the optical waveguides are stacked and interconnected with the reflective bodies. Subassembly 200, section J (shown enlarged in FIG. 2D) emphasizes the precision alignment of the optical fibers to the waveguides. In subassembly 200, reflective body portions, incorporating mirrors or reflective surfaces that may also collimate, redirect light signals within the optical subassembly. Subassembly 200 may also include lenses or other elements to further enable collimation. Such components are advantageous for managing light pathways and optimizing signal transmission between the PIC and the fibers. Having the curved or angled structures within the assembly reflect light efficiently, ensuring minimal loss and precise direction changes. As shown in FIG. 2D, the enlarged detail J of fiber ferrule 202 highlights the alignment holes and precise positioning mechanisms that ensure the optical fibers, waveguides and reflective bodies are accurately aligned.

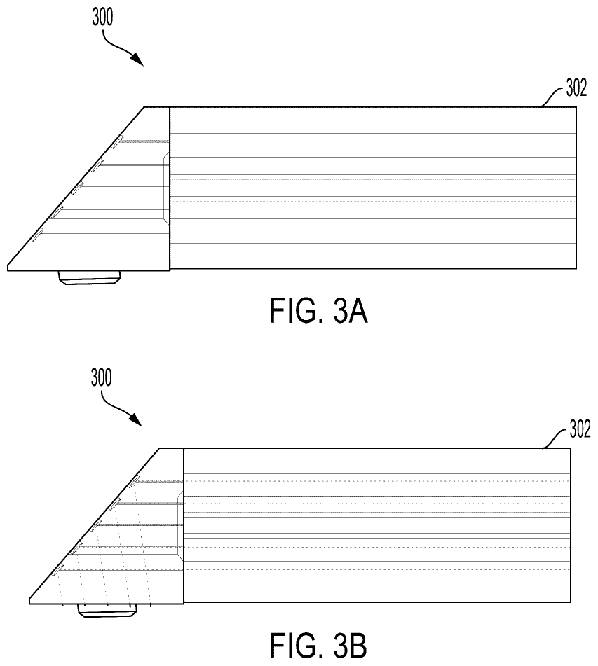

Referring now to FIGS. 3A-3D, FIG. 3A shows an optical subassembly 300 (“assembly 300”), in accordance with some embodiments. FIG. 3B depicts assembly 300 with optical paths shown. Assembly 300 is an embodiment of assembly 200, in which similarly labeled parts and numbers correspond to similar features having similar functionality. Assembly 300 dimensions, waveguides and mirrors further provide an advantageous structure for consideration of signal integrity, performance and manufacturability. In some embodiments, assembly 300 includes alignment holes and/or precise positioning mechanisms that ensure the optical fibers and reflective bodies are accurately aligned.

Such components are advantageous for managing light pathways from the PIC to the fiber. In subassembly 300, reflective bodies are shown as straight structures within the assembly, but could be curved to enable mode conversion such as collimated light to 9 um mode field diameters (MFD) supported by standard single mode fibers (SMF) or polarization maintaining fibers (PMF). Reflective bodies reflect light efficiently, ensuring minimal loss and precise direction changes. For example, in some embodiments, subassembly 300 includes straight waveguide channels and mirrors to redirect light. Other embodiments could include lenses or curved mirrors to reshape the light in addition to the waveguides and/or mirrors.

Accordingly, fiber ferrule 302 ensures precise alignment and high-density integration of optical fibers, while the reflective bodies efficiently redirect and/or reshape light signals within the subassembly and the waveguides enable ideal mode transmission through the body. Detailed close-ups and side views highlight the meticulous design and alignment features, showcasing the advanced engineering involved in creating this compact and efficient optical component. The assembly's dimensions and straight channels further demonstrate the careful consideration of signal integrity and performance in the design.

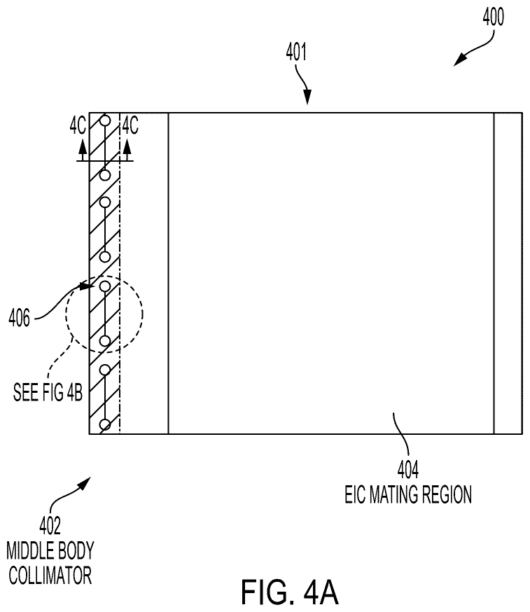

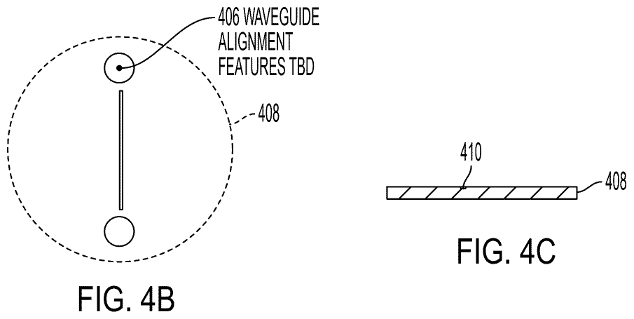

Referring now to FIG. 4A-4C, FIG. 4A shows a configuration of light extraction from the PIC with a straight waveguide array 400 (“PIC 400”). PIC 400 corresponds to an embodiment of component 110 for use in assembly 100. FIG. 4A shows a single line cavity where all waveguides are terminated. In the single line cavity is where the lower body reflector 108 may be inserted, in some embodiments. In some embodiments, PIC 400 includes mating region 401, which may include middle body collimator mating region 402, EIC mating region 404, and/or alignment features 406. In some embodiments, methods and processes corresponding to optical subassembly 100 and/or PIC 400 may include post-PIC thinning, TSV reveal, creating etched Z-stops, hybrid or fusion bonding and exposing optical waveguide facets, which is discussed in further detail below. FIGS. 4A-4C illustrate such specifications ensuring precise alignment, secure attachment, and optimal performance of the optical subassembly, in accordance with some embodiments.

In some embodiments, the array of waveguides in PIC 400 may range in total width from as small as 0.5 mm to as large as 25 mm with waveguide pitches of 10 um up to 250 um, providing flexibility in design to accommodate varying optical or product requirements. Such dimensions are advantageous in maintaining the balance between compact design and efficient optical performance. The flexibility in dimensions allows for customization based on specific application needs, ensuring compatibility with various optical components and systems.

In some embodiments, total width of the PIC 400, including all integrated components, ranges between 1 mm and 32 mm. Such density and ability to scale in width is advantageous for fitting the PIC into any form factor required while maintaining high performance and improved scalability and flexibility in system design. Such dimensions facilitate integration into space-constrained applications such as mobile devices, wearables, and compact communication modules and enables high-density optical interconnections in data centers and telecommunication networks.

In some embodiments, a so-called beachfront length may be 12 mm and include up to four connectors, as shown in FIG. 4A (and FIG. 1). For example, a length of the PIC may be specified as 12 mm, with a beachfront area that accommodates four optical connectors. For clarity, FIG. 4B depicts an enlarged view of one of the exemplary connector areas. The 12 mm length provides the space for integrating multiple optical components while maintaining a compact overall footprint. The beachfront area with four connectors ensures that the PIC can handle multiple optical fibers simultaneously, enhancing its capability for high-speed data transmission. The specified length and connector configuration support high data throughput, making the PIC suitable for applications requiring rapid and reliable data exchange. Moreover, the alignment features facilitate easy connection and disconnection of optical fibers, simplifying maintenance and upgrades, ensure compatibility with industry-standard optical connectors, and promote interoperability with existing optical networks and systems.

In some embodiments, post PIC thinning and TSV reveal method may include thinning the PIC and revealing Through-Silicon Vias (TSVs). Such methods and processes are advantageous for preparing the PIC for further integration and ensuring that the TSVs are properly exposed for electrical connections. For example, thinning the PIC ensures that it meets the required thickness specifications for wafer-scale manufacturing. Revealing TSVs involves polishing processes that expose these vertical interconnects, facilitating electrical connectivity between different silicon chips, substrates or interposers.

As shown in FIG. 4C, in some embodiments, optical subassembly mating region on the PIC 400 includes Etched Z-Stops 410 and exposed optical waveguides. Etched Z-stops provide precise vertical positioning, while exposing optical waveguides ensures that waveguides are ready for optical signal transmission into the lower body reflector 108. Z-stops are created using precision etching techniques to define specific depths, which help in aligning various components during assembly. Optical waveguides are exposed through the same controlled etching, ensuring that their surfaces are ready for light transmission with minimal loss.

In some embodiments, an electrical integrated circuit (EIC) and the lower body reflector 108 are aligned and placed onto the PIC in the same manufacturing stage. The lower body reflector includes reflective elements that direct and/or shape light vertically out of the PIC. The EIC integrates with the PIC to provide the full oEngine assembly. In other embodiments, the EIC and lower body reflector 108 are aligned and placed onto the PIC in two separate manufacturing stages.

In some embodiments, a mating region (which could be any material that is transparent to the wavelength of operation) is a specified area where the first reflector body 108 gets aligned and placed passively onto the PIC. This lower body reflector 108 can be made of glass or other materials that are transparent to the wavelength(s) of operation and can enable a high-reflectivity surface to turn and/or manipulate the light propagation direction and/or mode profile. In other embodiments, the lower body reflector is only comprised of the mirror portion and may not be transparent or otherwise interfere with the light path. The EIC mating region specifies where the electrical integrated circuit could be positioned. In some embodiments, such region measures 12.0 mm in length. Waveguide Alignment Features (Detail A in FIG. 4B) shows in a top view configuration of an example of mechanical alignment features for the optical waveguides. In some embodiments, dimensions of alignment features for the optical waveguides may include: a vertical waveguide array size: 1.5000 mm, a horizontal opening for lower body reflector 108: 0.0400 mm or greater. Such dimension ensures precise alignment of waveguides to the lower body reflector 108 to minimize signal loss and maintain integrity. For example, as shown in FIG. 4C, Section B-B, the cross-sectional view illustrating the small area in depth available to integrate the lower reflector body 108 into the cavity 410. In some embodiments, a total PIC thickness may be 0.1000 mm or less, and a Z-Stop Depth may be substantially 0.0150 mm (etched depth for precise vertical positioning). Such structural specifications are advantageous for manufacturing and quality control, which is discussed in further detail below.

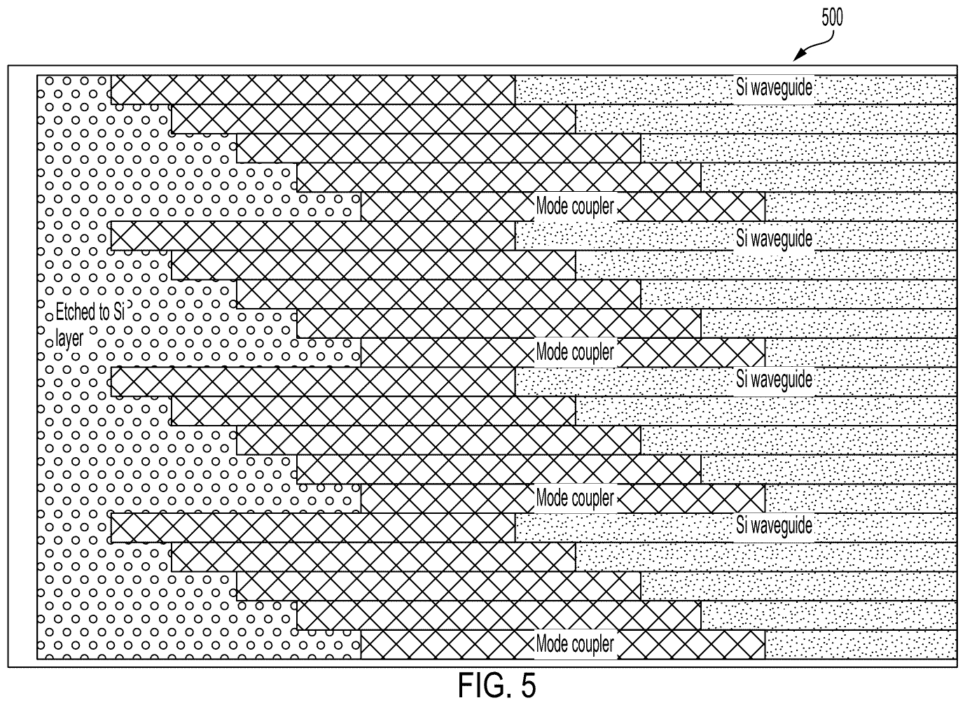

Referring now to FIG. 5, FIG. 5 shows a top view of an exemplary PIC 500 with multiple waveguides in a staggered configuration. The staggered configuration allows for very high density of optical waveguides within a compact footprint that can easily couple to the limitation on density imposed by fibers. Such design enhances the functionality and density of the PIC. PIC 500 includes a systematic arrangement to optimize light coupling and signal management.

In some embodiments, PIC 500 includes a Photonic Integrated Circuit (PIC) with staggered silicon waveguides and mode couplers integrated into a compact structure. Silicon mode couplers are devices that facilitate the coupling of light between different modes or waveguides. Mode couplers are advantageous for efficiently transferring light signals from one waveguide to another. Waveguides (e.g., Si Waveguides), may be utilized for guiding light signals within PIC 500. Such waveguides are the primary pathways for optical signals.

Etched to Si Layer indicates the depth of etching to the silicon substrate to enable light extraction from the mode couplers as well as to provide z-stop features necessary for passive alignment. The etching process defines the structures within the PIC. Within the etched cavity is the lower body reflector 108 enabling the light to turn from being in-plane to perpendicular to the surface. In other embodiments, the lower body reflector 108 may be inserted from the backside of the PIC.

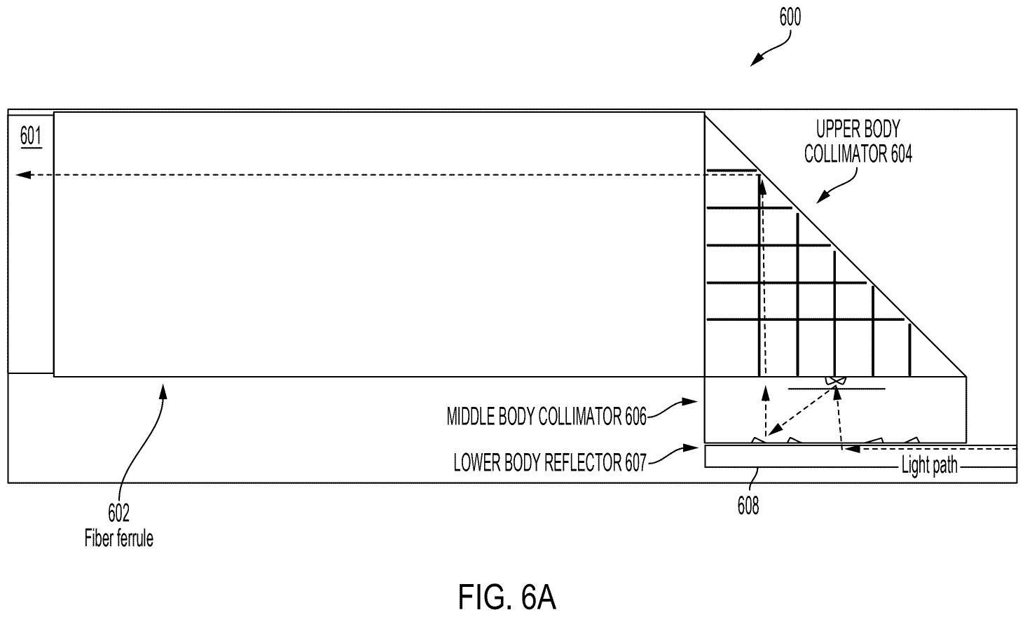

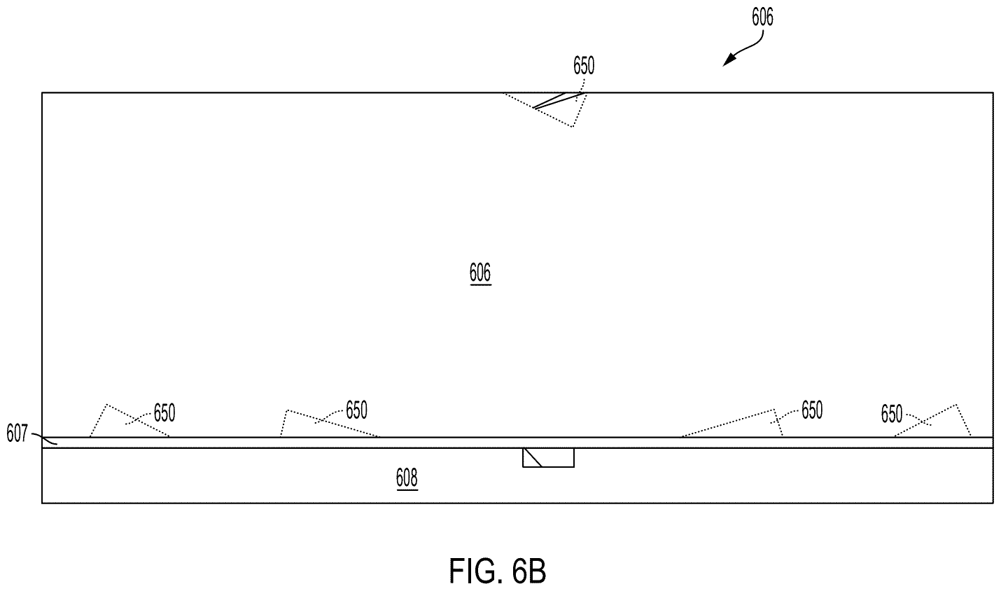

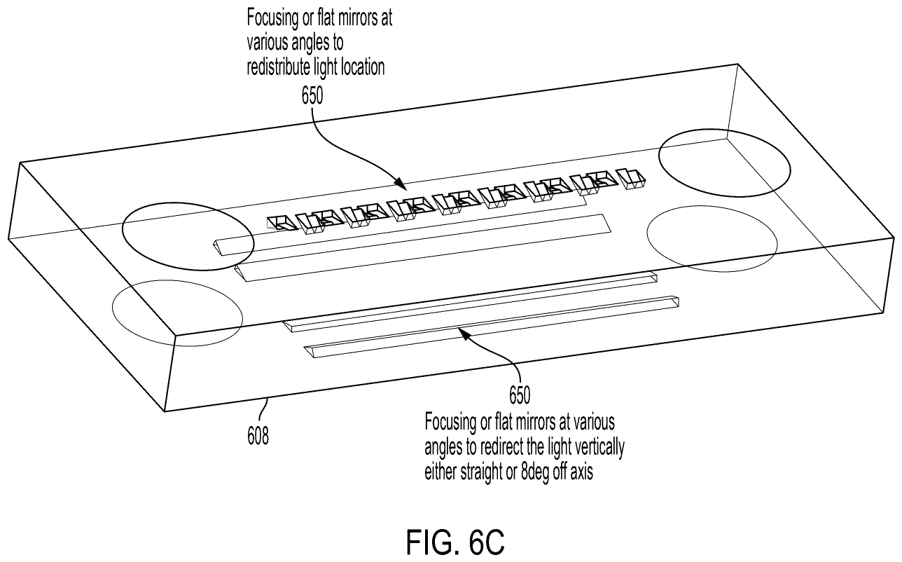

Referring now to FIG. 6A-6C in conjunction with FIGS. 1-5, FIG. 6A depicts optical subassembly 600 (“subassembly 600”). Subassembly 600 is an embodiment of system 100 in which similarly labeled parts and numbers correspond to similar features having similar functionality. In some embodiments, system 600 includes fiber 601, fiber ferrule 602, upper body collimator 604, middle body collimator 606, lower body reflector 607, and/or photonic integrated circuit (PIC) 608. In some embodiments, middle body collimator 606 may include an Optical Redistribution Layer or ORDL. In other embodiments, middle body collimator 606 includes mechanical alignment features to align to the upper body collimator. In other embodiments, those mechanical alignment features are a separate part stacked above the MBC 606. As shown in FIG. 6A, an exemplary path of light through the components of a PIC may include lower body reflector 607, middle body collimator 606 with ORDL, upper body collimator 604, and/or fiber ferrule 602.

As shown in FIG. 6B, the path of light is first directed by the lower body reflector body 607 from the PIC 608, which captures, redirects and may reshape such path of light towards middle body collimator with ORDL 606. ORDL 606 redistributes and/or reshapes the light, utilizing its array of mirrors 650 to spread the light from the tightly packed waveguide array from the PIC to a more spaced-out configuration needed for fiber alignment. The upper body collimator (e.g., shown in FIG. 6A) captures the light from middle body collimator with ORDL 606 and guides and/or shapes it for best optical loss performance towards the final output destinations. The light exits through the fiber ferrule, efficiently coupled into the external optical fibers.

In some embodiments, lower body reflector 607 may be advantageously positioned at the bottom layer above the PIC. In other embodiments, the lower body reflector 607 may be advantageously positioned below the PIC and inserted through the PIC for alignment to the waveguide. Lower body reflector 607 includes reflective surfaces that capture light from the input waveguides and redirect and/or reshape such captured light towards middle body collimator with ORDL 606. The precision of such reflective surfaces is advantageous for maintaining signal integrity and minimizing loss. Mirrors can be configured as flat or shaped spherically, aspherically, cylindrically, and the like. In some embodiments, reflective surfaces may be fabricated with materials that offer high reflectivity and durability, wherein lower reflector body 607 ensures minimal light scattering and optimal reflection angles to guide the light accurately into middle body collimator with ORDL 606.

As shown in FIG. 6A, middle body collimator with ORDL 606 is the central layer responsible for redistributing and/or reshaping optical signals between the waveguides and the output fibers. The middle body collimator with ORDL 606 operates as an intermediary that balances and manages light paths and shapes within the subassembly. As shown in FIG. 6B, by utilizing a dual-layer mirror system, the middle body collimator with ORDL 606 spreads light from a tightly packed waveguide array to a more spaced-out fiber array, ensuring efficient signal redistribution. Such middle body collimator with ORDL's dual-layer configuration handles high-density optical signals while minimizing crosstalk and signal degradation. Precise alignment features ensure that light is directed accurately from one layer to the next, maintaining high optical performance.

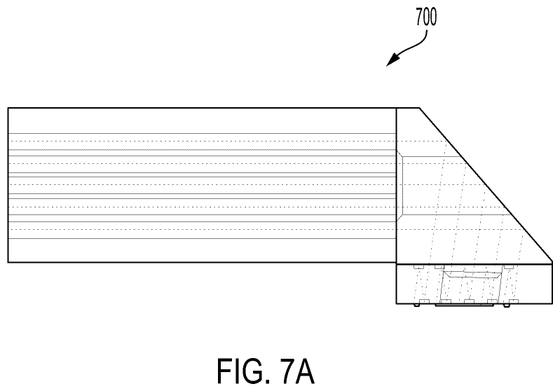

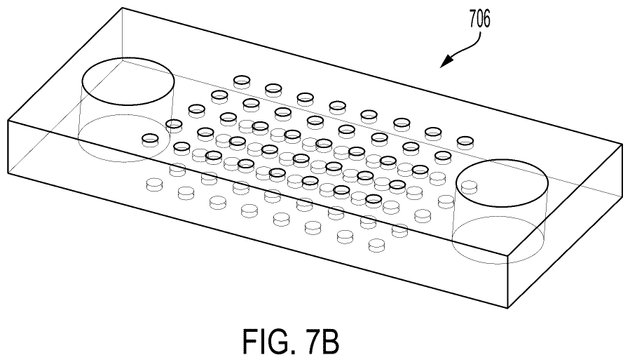

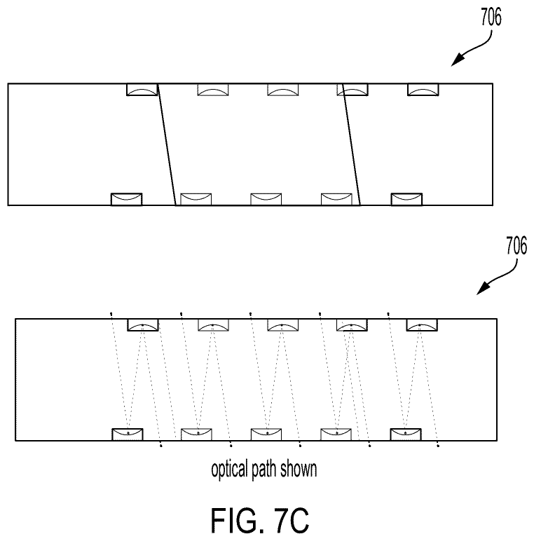

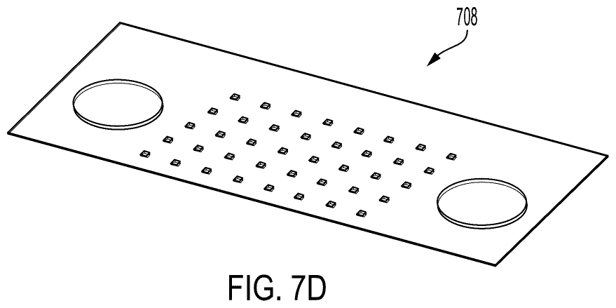

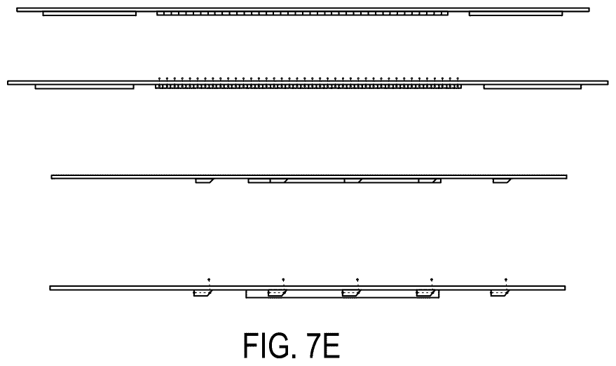

In some embodiments, ORDL 606 functionality of the middle body collimator may not be needed to spread the light, but is used for shaping the light profile for increased optical performance between the lower body reflector and upper body collimator as shown in FIG. 7A. In other embodiments, middle body collimator 606 may be used for precision mechanical alignment with no optical requirements. Such embodiments may be implemented together or individually, for example in a stacked configuration.

In some embodiments, the middle body collimator 606 may include features to enable the multiplexing and demultiplexing (Mux/Demux) of multiple wavelengths independent of polarization. Such capability is advantageous for enhancing the performance and versatility of photonic integrated circuits (PICs), particularly in applications requiring high data throughput and efficient use of optical bandwidth. The inclusion of Mux/Demux features within middle body collimator 606 allows for the combination of multiple optical signals at different wavelengths into a single optical fiber (multiplexing) and the separation of these signals back into individual wavelengths at the receiving end (demultiplexing). This process significantly increases the data transmission capacity of the optical connector, making it suitable for high-bandwidth applications such as data centers, telecommunications, and AI-driven computing. One advantage of such embodiment is the independence from polarization. For example, in traditional optical systems, the polarization state of light can affect the performance of Mux/Demux processes, leading to signal degradation and inefficiency. By incorporating polarization-independent Mux/Demux features, the middle body collimator 606 ensures that the multiplexing and demultiplexing processes are not affected by the polarization state of the incoming light. This results in more robust and reliable performance, as the system can handle varying polarization states without compromising signal integrity.

In some embodiments, polarization-independent Mux/Demux in the middle body collimator 606 may include one or more optical components such as arrayed waveguide gratings (AWGs), gratings in general, Mach-Zehnder interferometers (MZIs), and polarization diversity circuits. Such optical components are designed to manage different wavelengths and polarization states effectively. For instance, AWGs can separate and combine multiple wavelengths with high precision, while polarization diversity circuits can split and recombine light based on the polarization, ensuring that the Mux/Demux process remains unaffected by polarization changes.

In some embodiments, upper body collimator 604 may be positioned above middle body collimator 606. Upper body collimator 604 further directs and/or shapes light towards the final output destinations. Containing additional reflective or refractive surfaces, upper body collimator 604 captures light from the middle body collimator 606 and guides and/or shapes light towards the fiber ferrules, 602, ensuring efficient coupling into the output fibers.

In some embodiments, upper body collimator 604 includes alignment features that align with the middle body collimator 606 and fiber ferrules. The upper body collimator ensures seamless light transition and may implement materials with high reflectivity and precision-etched surfaces to maintain signal quality. In some embodiments, fiber ferrules 602 are configured for high precision to match the pitch and alignment requirements of the optical fibers and waveguides. Fiber ferrules 602 can also contain features to mechanically align to the upper body collimator.

In some embodiments, the middle body collimator 606 includes precision-engineered alignment holes designed to interface with corresponding features of the upper body collimator 604 and the fiber ferrule. These alignment holes enable accurate passive alignment during assembly and also support high-throughput testing in semiconductor manufacturing environments. Specifically, the middle body collimator 606 is configured to be temporarily and repeatably pluggable onto the photonic integrated circuit (PIC), enabling non-permanent but precise optical coupling suitable for test applications.

The ability to temporarily engage the middle body collimator 606 with the PIC allows for full-wafer testing of both optical and electrical subsystems before dicing. This aligns with existing high-volume testing workflows in semiconductor manufacturing, where electronic circuits are routinely probed at the wafer scale using automated probe stations. By providing a vertically pluggable optical interface, the middle body collimator 606 enables test heads to simultaneously engage electrical probe pads and optical ports across the wafer, allowing system-level optical-electrical validation at volume scale.

This architecture eliminates the need for costly, labor-intensive optical probe setups that are traditionally used for testing photonic devices. Instead, the pluggability of the middle body collimator 606 enables repeatable, high-fidelity coupling that maintains optical alignment without requiring active alignment or 6-axis adjustments. The middle body collimator 606 is compatible with passive, visual alignment techniques, and may be engaged with minimal mechanical effort during testing operations.

In addition to alignment holes, the middle body collimator 606 may include structural features such as detents, ridges, or spring interfaces that support robust temporary coupling to the upper body collimator 604 and the fiber ferrule. These features allow a single middle body collimator 606 test interface to be reused across multiple dies, further reducing test costs and increasing throughput. Because the light path remains fully enclosed within the middle body collimator 606 and the upper body collimator 604 during engagement, the assembly is resilient to dust, humidity, or contamination during testing-especially beneficial for high-density, high-radix applications where performance could otherwise be affected by environmental variables.

This integrated and sealed test architecture supports early validation of advantageous performance metrics such as coupling efficiency, mode field alignment, polarization independence, insertion loss, and broadband response, all prior to final packaging. In turn, this improves yield, lowers the risk of post-packaging failure, and reduces the need for downstream rework. The described features enable a modern, high-throughput, and scalable test interface suitable for production environments deploying next-generation photonic integrated circuit technologies.

In some embodiments, assembly 100, 600 may include collapsing bodies into single units for efficiency. For example, in some embodiments, the optical subassembly integrates multiple functional bodies into single units, enhancing efficiency and simplifying the manufacturing process. Collapsing multiple bodies into a single unit reduces overall complexity, simplifies the manufacturing process, and can lead to lower production costs. Such integration reduces the need for multiple alignment steps, enhancing the precision and reliability of the optical pathways. A more integrated design minimizes the footprint of the optical subassembly, making it suitable for applications with stringent space constraints.

For example, in one embodiment, the upper body collimator may be combined or collapsed with the fiber ferrule body. Such unified component structure streamlines the light redirection and coupling processes. Moreover, integrating the upper body collimator with the fiber ferrule ensures seamless light transfer between the two stages, reducing potential points of loss or misalignment. A single integrated component simplifies the assembly process, reducing the number of parts that need to be manufactured and aligned. A unified structure enhances the mechanical stability, reducing the risk of misalignment due to mechanical stress or thermal expansion. Yet the integrated component advantageously maintains the reflective properties and alignment features of both the upper reflector body and the fiber ferrule. Advanced materials and/or precision fabrication techniques are advantageous to achieving the desired performance of the upper body collimator. For example, in some embodiments, the tolerance to lateral misalignment relative to the middle body collimator includes up to substantially 30 micrometers. For other embodiments, the tolerance to angular misalignment includes up to substantially 1 degree.

In some embodiments, after initial redirection by the lower body reflector, the light signals are redistributed to match the fiber pitch, which typically ranges from 127 to 250 microns. Such redistribution process involves spreading the light signals from a tightly packed waveguide array to a configuration that matches the pitch of the output fibers. This is achieved through either middle body collimator with ORDL 606 or the PIC itself as shown in FIG. 5A. Matching the fiber pitch is advantageous for efficient coupling of light signals into the output fibers, minimizing insertion loss and ensuring high data transmission rates.

The lower body reflector contains strategically placed mirrors that capture, redirect and/or reshape light signals from the silicon waveguides. These mirrors are designed to reflect light at precise angles and with appropriate light beam shape, directing the (signal or laser) light towards middle body collimator 606. The placement, shape, and orientation of these mirrors are advantageous for maintaining the correct light path to and from the PIC and the middle body collimator 606. Proper mirror placement and shape in the lower body reflector ensures that light signals are accurately directed with minimal loss, setting the stage for effective redistribution and/or reshaping of the light by middle body collimator 606.

As shown in FIG. 6B, middle body collimator with ORDL 606 includes mirrors 650 on both top and bottom halves, which either convert light from a tight waveguide pitch to a spaced fiber pitch or reshape light for low loss, or both. Mirrors 650 in the middle body collimator with ORDL 606 redistribute the light signals by reflecting them from a tightly packed waveguide array to a more widely spaced configuration that matches the fiber pitch. These mirrors can also reshape the light by having curvature. Such conversion is essential for ensuring that the light signals may be efficiently coupled into the output fibers from the PIC, facilitating high-density optical connections and optimal performance.

In some embodiments, a fiber pitch in many optical systems is around 127 microns. In some embodiments, the waveguide pitch on the PIC in the optical subassembly can be advantageously tuned to 20 microns, or substantially 20 microns. A tighter waveguide pitch allows for higher density integration of optical components, enabling more compact and efficient designs. Setting the waveguide pitch to 20 microns advantageously enhances the overall performance and scalability of the optical subsystem, allowing for increased data transmission rates and radix as well as better utilization of space. In some embodiments, the dual-layer mirror configuration ensures that light signals are efficiently redirected with minimal loss to the fiber pitch, maintaining signal integrity and performance.

The middle body collimator with ORDL 606 is configured to redistribute light from a tight waveguide pitch to a two-dimensional fiber array. By spreading the light signals across a 2D array and reshaping the light, ORDL 606 facilitates efficient coupling into the output fibers, supporting high-density optical connections. Such redistribution is advantageous for optimizing the performance of the optical subassembly, ensuring that light signals are transmitted with high efficiency and low loss. In some embodiments, the middle body collimator with ORDL 606 includes alignment holes that are used to precisely position the upper body collimator and/or the fiber ferrule. These alignment holes ensure that all components are accurately aligned during assembly, maintaining the correct light pathways and minimizing signal loss without the need for active alignment. Proper alignment using passive alignment technology is advantageous for the effective operation of the optical subassembly, ensuring that light signals are accurately directed through each stage of the system at low cost and high volume. In other embodiments such alignment holes are contained in another component and stacked on top of the ORDL 606 to form the full structure.

In some embodiments, the middle body collimator with ORDL 606 is configured to be pluggable, allowing for easy vertical testing and wafer-scale assembly. This pluggable design facilitates testing of the optical subassembly components during manufacturing, ensuring that they meet performance specifications before final assembly. Pluggability enhances the manufacturability and testability of the optical subassembly, reducing production costs and improving overall reliability.

In some embodiments, the upper body collimator may be pluggable to middle body collimator 606, while middle body collimator 606 is fixedly attached to the lower body reflector and/or PIC. Such configuration ensures stable alignment and efficient light redistribution within the optical connector. In another embodiment, the upper body collimator may be pluggable to an alignment layer that is fixedly attached to the middle body collimator 606 depending on manufacturing constraints. In another embodiment, fiber ferrule 602 may be pluggable to the upper reflector body, which may provide additional flexibility and ease of assembly.

For example, in some embodiments, changes in the number, location, and curvature of reflectors or refractors are implemented. The optical subassembly of the embodiments herein allows for adjustments in the number, location, and curvature of the reflectors or refractors to optimize performance. By modifying the number, location, and curvature of the reflectors or refractors, the light pathways can be fine-tuned to achieve better signal integrity and minimize loss. Such flexibility in reflector and/or refractor design enables the optical subassembly to be customized for different applications, ensuring optimal performance across a range of operating conditions.

In some embodiments, the lower body reflector may include advanced features similar to or the same as middle body collimator 606. For example, in the lower body reflector may include multiplexing and demultiplexing (Mux/Demux) of multiple wavelengths independent of polarization similar to middle body collimator 606 described above. In some embodiments, the lower body reflector may include reflective features with different shapes such as spherical or cylindrical surfaces. In some embodiments the lower body reflector may control the light in one or more dimensions, depending on the application needs. Such customization ensures that the light is directed accurately towards the middle body collimator without the need for redistribution.

Moreover, implementing advanced features, supra, integrated into the lower body reflector simplifies the overall manufacturing and assembly process. For instance, etching and fabrication steps can be more targeted and precise, reducing complexity and potential errors. Additionally, the use of pluggable design elements allows for easier testing and alignment during assembly, improving production efficiency and reducing costs.

In some embodiments, the middle body collimator 606 comprises a combination of optical and mechanical structures that may be implemented as one or more unitary or assembled bodies. For example, the middle body collimator 606 may include a first body that comprises the optical elements, such as lenses, mirrors, waveguides, or other collimating elements configured to shape and/or redirect light. A second body may include mechanical features such as clips, tabs, pins, notches, or other engagement structures, which are configured to mate and/or demate with a third body, such as the upper body collimator 604. In some implementations, the first and second bodies are fabricated separately and subsequently joined, while in other embodiments, they may be formed as a monolithic component.

The structure and alignment of these bodies are designed to support precise mating with the upper body collimator 604, while enabling the redistribution of light from an output pattern of the photonic integrated circuit (PIC) to match an input pattern of the upper body collimator 604. As used herein, the term “input pattern” of the upper body collimator refers to the physical arrangement or spatial configuration of its optical interfaces (e.g., waveguides or fiber alignment holes) that are intended to receive light emitted by the middle body collimator 606. The flexibility in physical configuration allows for support of various geometries, such as transitioning from a tightly pitched PIC waveguide array (e.g., 20 μm pitch) to a more widely spaced fiber interface (e.g., 127-250 μm pitch).

In some embodiments, the mechanical features of the second body may be compatible with passive, visual alignment approaches, meaning that no active feedback or six-axis alignment procedures are required to achieve a functional and efficient optical interface. This approach supports scalable manufacturing processes and enables high-volume assembly and testing at the wafer level. This modular and flexible design ensures that variations in mechanical engagement and optical redistribution are within the scope of the embodiments herein, whether fabricated as distinct elements or integrated into a single physical component.

Referring now to FIGS. 7A-7E, FIG. 7A represents an exemplary structure 700 of the lower body reflector, middle body collimator, upper body collimator and a fiber ferrule that could be designed in conjunction with a PIC 500 layout. FIG. 7B depict the middle body collimator 706 in accordance with some embodiments. FIG. 7C depicts an optical path of the middle body collimator 706, in accordance with some embodiments. As shown in FIG. 7B, in one embodiment of the middle body collimator (e.g., 706), the optical path (shown in FIG. 7C) is configured to optimize light management using identical reflectors on each surface. Such configuration simplifies the manufacturing process significantly by eliminating the need to redistribute the location of the light path. Instead, the focus is on reshaping the light in a way that allows it to propagate the necessary distances effectively with minimal loss. The reshaping the light in this context is achieved by altering the shape of the mirrored surface within the middle body collimator. Specifically, the mirrors are designed with different profiles that can be spherical, cylindrical, conical, or aspherical. Additionally, such mirrors may adjust an angle of light propagation such that the light exiting the PIC can match the angle required for the UBC, thus providing significant flexibility in the design of both the PIC turning elements, whether they are grating couplers or a LBR, and the UBC.

FIG. 7D shows an embodiment of a lower body reflector 708 with cross-sectional views shown in FIG. 7E. As shown in FIG. 7D, in some embodiments, the reflector profiles may be varied to control the light path in precise ways. For example, a mirror with a spherical surface controls light uniformly in all directions, whereas a cylindrical surface controls light in one dimension. These options provide flexibility in designing the optical paths to suit specific requirements. The profiles may be adjusted to ensure that the light is redirected in the most efficient manner possible, depending on the application.

Some exemplary implementations include an upper body collimator including a first body including more than two rows of fiber alignment holes, one or more alignment features configured to mate and/or demate with a second body external to the upper body collimator, and one or more optical structures including one or more: waveguides, lenses, mirrors, and/or light manipulating surfaces. In some embodiments, the more than two rows of fiber alignment holes and the one or more optical structures are collectively configured to emit collimated light across an interface with the second body, with a tolerance to lateral and/or angular misalignment.

In some embodiments, the tolerance to lateral misalignment includes up to substantially 20 micrometers and a tolerance to angular misalignment includes up to substantially 1 degree. An individual row of the more than two rows of fiber alignment holes includes at least two fiber alignment holes. The one or more optical structures are integrated within the first body.

In some embodiments, the one or more optical structures are external to the first body and optically aligned with an individual fiber alignment hole of the two rows of fiber alignment holes. In some embodiments, light exits the collimator at a perpendicular angle with respect to a plane of the first body or light exits the collimator at an oblique angle with respect to a plane of the first body, or an acute angle with respect to a plane of the first body, are an angle between +/−45 degrees. In some embodiments, the UBC includes an anti-reflective (AR) coating along one or more optical pathways and/or a high reflectivity (HR) coating along one or more optical pathways. In some embodiments, include a design such that total internal reflection (TIR) creates the high reflectivity needed along one or more optical pathways. In some embodiments, one or more mechanical features configured for removably coupling the first body with external components, the one or more mechanical features being apart from the one or more alignment features. In some embodiments, the upper body collimator may be removably coupled to a ring stiffener, a lid, and/or a substrate to support optical packaging.

In some embodiments, the fiber alignment holes are optically aligned with one or more waveguides integrated within the first body. The upper body collimator includes one or more waveguides or fiber alignment holes are optically aligned with mirrors configured to reflect or redistribute light. The waveguides and mirrors are optically aligned with lenses that collimate light output from the fiber alignment holes. The mirrors are designed to create collimation without the need for additional lenses and are optically aligned with the waveguides and/or fiber alignment holes.

In some embodiments, the fiber alignment holes are configured to accommodate fibers having a pitch between 50 micrometers and 250 micrometers, and fiber diameters (core+cladding) between 50 micrometers and 125 micrometers. In some embodiments, optical fibers having mode field diameters between 4 micrometers and 10 micrometers. The emitted collimated light is configured to couple with another collimating element including one or more: lenses, mirrors, and/or diffractive grating couplers. The collimated light is polarization independent and broadband in wavelength.

In some embodiments, the middle body collimator includes a first body including more than two rows of collimating elements, a second body including one or more mechanical features, wherein the one or more mechanical features are configured to mate and/or demate with the second body, or wherein the second body and the one or more mechanical features are monolithic, one or more alignment features configured to facilitate passive visual alignment with a photonic integrated circuit (PIC), In some embodiments, the middle body collimator is configured to emit collimated light and redistribute the light to match an output pattern of the PIC to an input pattern of the second body, wherein the passive visual alignment does not include active or six-axis alignment. In some embodiments, one or more alignment features are configured to support pick-and-place assembly processes. The redistribution of light adjusts a pitch between light channels from approximately 10 micrometers to up to 250 micrometers and the angle between the PIC and the second body to enable low loss optical coupling and optimization of the PIC reflector design from the second body design.

In some embodiments, the MBC includes one or more optical elements configured to reflect light along multiple surfaces within the body. At least one of the reflecting surfaces is configured to reshape the light beam, is coated with a high reflectivity (HR) mirror, and/or uses total internal reflection (TIR) to enable reflectivity. In some embodiments, middle body collimator includes one or more optical elements configured to perform multiplexing or demultiplexing of optical signals, which enable polarization-independent operation and increased bandwidth density.

In some embodiments, the middle body collimator wherein the first body defines a sealed internal optical path to provide environmental protection from dust, humidity, or immersion in fluid. The middle body collimator wherein the body is compatible with semiconductor manufacturing processes, including reflow or other JEDEC-standard processes. The middle body collimator wherein the collimator is optically aligned with a turning element in the PIC, including a grating coupler or a mirror. The middle body collimator wherein the collimator is configured to accommodate PIC output angles ranging from 0 degrees to 45 degrees from normal to surface. The collimator is polarization independent and operates across a broadband wavelength range. Wherein the body is free of epoxy within the optical path. In some embodiments, the first body comprises a monolithic or multi-layered optical structure with integrated redirection and pitch-matching functionality.

In some embodiments, a lower body reflector (LBR) for a photonic integrated circuit (PIC), includes a broadband turning mirror embedded within the PIC and configured to redirect optical signals, wherein the lower body reflector is manufacturable using standard PIC fabrication processes and is integrated without epoxy or organic bonding materials. In some embodiments, the lower body reflector is configured to direct light exiting the PIC at an angle ranging from surface normal to ±45 degrees from normal.

In some embodiments, the broadband turning mirror is fabricated as a linear array having a pitch of 10 micrometers or greater and/or as a two-dimensional (2D) array with 2 or more rows. In some embodiments, the lower body reflector is configured to support mode field diameters between approximately 2 micrometers and 10 micrometers with high optical coupling efficiency. In some embodiments, the lower body reflector is monolithically integrated into the PIC using lithography, dielectric deposition, etching, and metallization steps compatible with CMOS or similar processes. In some embodiments, the lower body reflector supports optical coupling between the PIC and a collimating component.

In some embodiments, the broadband turning mirror comprises a reflective surface formed at an 45°, oblique or acute angle within a cavity etched into the PIC substrate. The broadband turning mirror may be polarization-independent and operates over a wavelength range spanning at least one of the O-, C-, and L-bands. In some embodiments, the reflector comprises of a stack of dielectric and/or metal to create a high reflectivity (HR) mirror. In some embodiments, the reflector is fabricated on a separate wafer and integrated using fusion bonding to the PIC wafer. In some embodiments the reflector fits into pre-etched cavities in the PIC wafer. In some embodiments, the remaining substrate of the LBR is thinned or removed to facilitate through silicon vias for electrical connections. The separate wafer can be placed on the top surface or the backside surface of PIC to enable turning.

In some embodiments, the structure supporting the mirror is comprised of material that is transparent to the wavelengths of operation. The reflection can exit vertically up or down out of the PIC surface. Additional passive optical components, such as multiplexers and demultiplexers, waveguides, splitters, and/or combiners may enable improved bandwidth density.

In some embodiments, a photonic coupling system includes an upper body collimator including fiber alignment holes, alignment features configured to mate with a matching body, and one or more optical structures including waveguides, lenses, mirrors, or other light manipulating surfaces, the upper body collimator configured to emit collimated light across a de-mating interface with tolerance to lateral or angular misalignment. A middle body collimator optically coupled to the upper body collimator, the middle body collimator including collimating elements, mechanical features configured to mate with the upper body collimator, and optical elements configured to redistribute light and reflect light internally. A lower body reflector integrated with or adjacent to a photonic integrated circuit (PIC), the lower body reflector comprising a broadband reflective surface configured to redirect light into the PIC;

In some embodiments, the elements fixedly attached to the package (middle body collimator and lower body reflector) are free of epoxy or other organic bonding materials in the optical path and support broadband, polarization-independent optical coupling. In some embodiments, the de-mating interface maintains alignment tolerance of up to approximately 20 micrometers. In some embodiments, wherein the de-mating interface maintains alignment tolerance of up to substantially 1°.

In some embodiments, the upper body collimator includes antireflective (AR) coatings along one or more internal surfaces. In some embodiments, the middle body collimator includes alignment features configured for passive placement using pick-and-place assembly. In some embodiments, the middle body collimator is configured to convert an optical pitch or angle from a first configuration to a second configuration. In some embodiments, the middle body collimator includes elements configured to reshape, guide, split, combine, multiplex, or demultiplex the light.

In some embodiments, the lower body reflector is embedded into the PIC using standard semiconductor manufacturing processes. In some embodiments, the lower body reflector is configured to redirect light at an angle ranging from surface normal to approximately ±45 degrees. In some embodiments, the optical path between the upper body collimator and the PIC remains environmentally sealed. In some embodiments, the system is compatible with reflow soldering or other semiconductor packaging protocols. In some embodiments, the lower body reflector includes elements configured to reshape, split, combine, multiplex, or demultiplex the light.

In some embodiments, a photonic coupling system includes an upper body collimator including fiber alignment holes, alignment features configured to mate with a matching body, and one or more optical structures comprising waveguides, lenses, mirrors, or light manipulating surfaces, and an optical lens configured to receive collimated light from the upper body collimator and redirect the light toward a grating coupler (GC) of a photonic integrated circuit (PIC). In some embodiments, the standard optical lens includes mechanical mating features corresponding to the alignment features of the upper body collimator.

In some embodiments, a photonic coupling system includes an upper body collimator including fiber alignment holes, alignment features configured to mate with a matching body, and one or more optical structures comprising waveguides, lenses, mirrors, or light manipulating surfaces, a standard optical lens optically coupled to the upper body collimator and configured to redirect light toward a photonic integrated circuit (PIC), and a lower body reflector integrated with or adjacent to the PIC, the lower body reflector comprising a broadband reflective surface configured to redirect light into the PIC. In some embodiments, the optical lens includes mechanical mating features corresponding to the alignment features of the upper body collimator.

In some embodiments, a photonic coupling system includes an upper body collimator including fiber alignment holes, alignment features configured to mate with a matching body, and one or more optical structures comprising waveguides, lenses, mirrors, or light manipulating surfaces, and a middle body collimator optically coupled to the upper body collimator, the middle body collimator including collimating elements, mechanical features configured to mate with the upper body collimator, and optical elements configured to redistribute light and reflect light internally. In some embodiments, the middle body collimator is configured to redirect light toward a grating coupler of a photonic integrated circuit (PIC).

In some embodiments, a method of assembling an optical coupling system includes: aligning an upper body collimator including fiber alignment holes and optical structures with a middle body collimator including collimating elements and optical redirection features and mating the upper body collimator and middle body collimator using passive alignment features. In some embodiments, coupling the middle body collimator to a lower body reflector integrated with a photonic integrated circuit (PIC), and redirecting light from the upper body collimator through the middle body collimator and into the PIC via the lower body reflector. In some embodiments, forming the optical coupling system without using epoxy or other organic materials in the optical path for components fixedly attached to the PIC.

In some embodiments, aligning includes passively placing the middle body collimator onto the PIC using visual or mechanical alignment features. In some embodiments, the middle body collimator adjusts an optical pitch or angle between the upper body collimator and the PIC. In some embodiments, reshaping or collimating the light using one or more lenses or mirrors disposed within the middle body collimator. In some embodiments, the lower body reflector is bonded to the PIC using hybrid or fusion bonding. In some embodiments, the lower body reflector redirects light at an angle between normal incidence and ±45 degrees. In some embodiments, the light pathway remains environmentally sealed between the upper body collimator and the PIC.

In some embodiments, the optical system is compatible with high-volume semiconductor manufacturing processes including reflow soldering. In some embodiments, aligning the fiber alignment holes with corresponding waveguides or turning elements within the upper body collimator. In some embodiments, waveguiding, splitting, combining, multiplexing or demultiplexing signals within the middle body collimator and/or the lower body reflector.

In some embodiments, a photonic integrated circuit (PIC) package includes a PIC having including a lower body reflector embedded or bonded to the PIC and configured to redirect light toward an external interface and a middle body collimator disposed above the lower body reflector, the middle body collimator including collimating elements and optical redirection structures configured to align with the lower body reflector and with an upper body collimator. In some embodiments, the PIC package is configured to interface with the upper body collimator to form an epoxy-free, broadband, polarization-independent optical coupling path.

In some embodiments, a photonic integrated circuit (PIC) package includes a PIC including a grating coupler for receiving light from an external interface; and an optical lens configured to couple light from an upper body collimator to the grating coupler, the optical lens including mechanical alignment features configured to align with corresponding features of the upper body collimator. In some embodiments, the PIC package is configured to form a broadband, polarization-independent optical interface with the upper body collimator.

In some embodiments, a photonic integrated circuit (PIC) package includes a PIC including a lower body reflector embedded or bonded to the PIC and configured to redirect light toward an external interface; and an optical lens optically aligned with the lower body reflector and configured to couple light from an upper body collimator to the lower body reflector. In some embodiments, wherein the standard optical lens includes mechanical alignment features configured to align with corresponding features of the upper body collimator, and the PIC package forms a broadband, polarization-independent optical coupling path.

In some embodiments, a photonic integrated circuit (PIC) package a PIC including a grating coupler for receiving light from an external interface, and a middle body collimator including collimating elements and optical redirection structures configured to align with the grating coupler and an upper body collimator. In some embodiments, the middle body collimator is configured to couple light between the upper body collimator and the PIC via the grating coupler in a broadband, polarization-independent manner.

In some embodiments, a pluggable connector module for coupling light to a photonic integrated circuit (PIC), includes: an upper body collimator including fiber alignment holes and one or more optical structures configured to collimate light. A middle body collimator optically coupled to the upper body collimator and including elements for collimating, redirecting, or multiplexing light. Alignment features configured to mate the connector module with a PIC package including a lower body reflector. In some embodiments, the connector module is configured to interface with the PIC package to form an epoxy-free, broadband, polarization-independent optical link.

In the embodiments herein, subassembly 100, 600, 700 components (e.g., 102, 104, 106, and/or 108, 602, 604, 606, 608, 706, 708) as part of or apart from the Optical Engine may facilitate communication with a number of processing units (e.g., xPUs), switch ASICs, memory, or other similar ASICs requiring off-chip communication. One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide non-transitory machine readable instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Thus, the foregoing embodiments of the optical assemblies and Optical Redistribution Layer (ORDL) in the optical connector system highlight significant advancements in the management and redirection of light signals within photonic integrated circuits. By incorporating reflectors on the top and bottom layers, varying mirror profiles, and innovative pluggability features or a combination of portions of these elements, the embodiments herein simplify manufacturing, enhance performance, and provide flexibility for testing and assembly. These improvements result in a high-density, efficient, and reliable optical connector that meets the increasing demands of AI-driven applications, data centers, and telecommunications. The advanced middle body collimator (with or without ORDL) design not only addresses current bandwidth and signal integrity challenges while enabling optimizations in the PIC and the UBC to be independent but also positions the optical connector system for scalability and future technological growth, ensuring it remains at the forefront of photonic integration technology.

The embodiments described herein may be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages. Furthermore, any reference to this disclosure in general or use of the word “embodiment” in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. An upper body collimator comprising:
a first body including more than two rows of fiber alignment holes;
one or more alignment features configured to mate and/or demate with a second body external to the upper body collimator; and
one or more optical structures including one or more: waveguides, lenses, mirrors, and/or light manipulating surfaces;
wherein the more than two rows of fiber alignment holes and the one or more optical structures are collectively configured to emit collimated light across an interface with the second body, with a tolerance to lateral and/or angular misalignment.

2. The upper body collimator of claim 1, wherein the one or more optical structures are external to the first body and optically aligned with an individual fiber alignment hole of the two rows of fiber alignment holes.

3. The upper body collimator of claim 1, wherein the fiber alignment holes are optically aligned with one or more waveguides integrated within the first body.

4. The upper body collimator of claim 1, further configured to removably couple the upper body collimator to a ring stiffener, a lid, and/or a substrate to support optical packaging.

5. The upper body collimator of claim 1, wherein the mirrors are designed to create collimation without the need for additional lenses and are optically aligned with the waveguides and/or fiber alignment holes.

6. The upper body collimator of claim 1, wherein the fiber alignment holes are configured to accommodate fibers having a pitch between 50 micrometers and 250 micrometers, and fiber diameters (core+cladding) between 50 micrometers and 125 micrometers.

7. The upper body collimator of claim 1, wherein the emitted collimated light is configured to couple with another collimating element including one or more: lenses, mirrors, and/or diffractive grating couplers.

8. The upper body collimator of claim 1, wherein the collimated light is polarization independent and operates over a wavelength range spanning at least one of the O-, C-, and L-bands.

9. A middle body collimator comprising:
a first body including more than two rows of collimating elements;
a second body including one or more mechanical features, wherein the one or more mechanical features are configured to mate and/or demate with a third body, or wherein the second body and the one or more mechanical features are monolithic; and
one or more alignment features configured to facilitate passive visual alignment with a photonic integrated circuit (PIC);
wherein the middle body collimator is configured to emit collimated light and redistribute the light to match an output pattern of the PIC to an input pattern of the third body, wherein the passive visual alignment does not include active or six-axis alignment.

10. The middle body collimator of claim 9, wherein the redistribution of light adjusts a pitch between light channels from approximately 10 micrometers to up to 250 micrometers.

11. The middle body collimator of claim 10, wherein at least one of the reflecting surfaces is configured to reshape and/or collimate the light beam.

12. The middle body collimator of claim 9, wherein the one or more optical elements are polarization-independent and operate over a wavelength range spanning at least one of the O-, C-, and L-bands and could enable multiplexing or demultiplexing, waveguides, splitters, and/or combiners to increased bandwidth density.

13. The middle body collimator of claim 9, wherein the collimator is optically aligned with a turning element in the PIC, including a grating coupler or a mirror.

14. A lower body reflector (LBR) for a photonic integrated circuit (PIC), comprising a broadband turning mirror embedded within the PIC and configured to redirect optical signals, wherein the lower body reflector is manufacturable using standard PIC fabrication processes and is integrated without epoxy or organic bonding materials, and wherein the lower body reflector is configured to direct light exiting the PIC at an angle ranging from surface normal to ±45 degrees from normal.

15. The lower body reflector of claim 14, wherein the broadband turning mirror is fabricated as a two-dimensional (2D) array with 2 or more rows.

16. The lower body reflector of claim 14, wherein the lower body reflector is monolithically integrated into the PIC using lithography, dielectric deposition, etching, and metallization steps compatible with CMOS or similar processes.

17. The lower body reflector of claim 14, wherein the broadband turning mirror is polarization-independent and operates over a wavelength range spanning at least one of the O-, C-, and L-bands.

18. The lower body reflector of claim 14, wherein the reflector is fabricated on a separate wafer and integrated using fusion bonding to the PIC wafer, wherein the reflector fits into pre-etched cavities in the PIC wafer.

19. The lower body reflector of claim 18, wherein a remaining substrate of the LBR is thinned or removed to facilitate through silicon vias for electrical connections.

20. The lower body reflector of claim 14, wherein additional passive optical components, such as multiplexers and demultiplexers, waveguides, splitters, and/or combiners can enable improved bandwidth density.
